(19) United States
(12) Patent Application Publication
(10) Pub. No.: US 2006/0022083 A1
(43) Pub. Date: Feb. 2, 2006

(54) Marking of objects for speed and spin measurements

(76) Inventors: Christopher Michael Sumpter, Wigston (GB); Roy Jones, Loughborough (GB); Paul John Neilson, Shepshed (GB)

Correspondence Address: SMITH-HILL AND BEDELL, P.C., 16100 NW CORNELL ROAD, SUITE 220, BEAVERTON, OR, 97006, US

(21) Appl. No.: 10/526,832

(22) PCT Filed: Sep. 3, 2003
(86) PCT No.: PCT/GB03/03796

§ 371 Date: Apr. 11, 2005

(30) Foreign Application Priority Data
Sep. 3, 2002 (GB) 0220364.4
Aug. 28, 2003 (GB) 0320124.1

(51) Int. Cl. G01P 3/68; G01P 3/64

(52) U.S. Cl. 244/3.1

(57) ABSTRACT

A system for measuring the flight of a projectile, comprising: a projectile comprising an exterior surface and a set of orientation identifiers distributed over the exterior surface, such that, for every orientation of the projectile, there exists, from any fixed perspective, a unique viewable configuration of a sub-set of the identifiers; means for capturing a first image of the surface of the projectile at a first time, the first image including a first configuration of a first sub-set of the orientation identifiers; means for determining the orientation of the projectile from the first configuration; means for capturing a second image of the surface of the projectile at a second time, the second image including a second configuration of a second sub-set of the orientation identifiers; means for determining the orientation of the projectile from the second configuration; and means for determining the rotational velocity of the projectile in flight from its orientation at the first time and its orientation at the second time. Also describes a method of determining the placement of orientation identifiers on the exterior surface of a projectile. A random set of dots or coloured tessellated panels is checked to determine ambiguities in orientation determination, and the set of identifiers is reduced as far as possible in an iterative cycle.

### FIELD OF THE INVENTION

This invention relates to a method of marking projectiles, and particularly to a method of marking balls used in a sporting context, that enables the projectiles' orientation in space to be more easily determined, and a system for monitoring movement imparted to such projectiles, to enable the projectile's translational and rotational movement in space to be determined.

### REVIEW OF THE ART KNOW TO THE APPLICANT(S)

Many sports involve the use of projectiles during the course of play. In most cases these are balls, usually approximately spherical in shape, and of a variety of sizes. Some sports such as rugby use non-spherical balls, and others such as ice hockey and discus-throwing use essentially disc-shaped objects. A common feature in the practice of these sports is the importance of the spin on the projectile, for a number of reasons. By causing the ball to spin, a skilled player can make the ball curve in flight as a result of the induced pressure differential across the ball; this phenomenon is known as the Magnus effect. Spin can also be of importance to subsequent movement of the ball following impact, such as causing a golf ball to stop moving when it hits the green, causing a table tennis ball to rebound from the table at unpredictable angles, and affecting the movement of cue and target balls in sports such as snooker and billiards.

Such is the central importance of spin to many ball sports that it is useful to be able to measure the rate and axis of spin of a ball. This can be used in the training of sports people, and can be helpful when designing sports equipment such as shoes, clubs, bats and, of course, the balls themselves.

Several approaches to measuring the spin rate of balls have been proposed, but all suffer a number of disadvantages. U.S. Pat. o. 6,157,898 discloses a device for measuring the movement, including spin, of a movable object such as a sports ball. The method requires that a radio transmitter is attached to the object under study. This highly technological solution to the problem clearly has drawbacks in terms of cost, and the additional device secured to the object is likely to effect the object's behaviour in flight.

The UK Patent Application o. GB2319834, and U.S. Pat. o. 5,798,833 describe a machine and method for measuring the rotational speed of a flying object. The device operates by analysing light reflected from a flying object that has been treated to have a reflective mark on it. The frequency of fluctuations of the reflected light is then used to estimate the rotational speed of the object. A drawback of this technique is that it requires an extended period of measurement in order to determine the fluctuation frequency, and gives no indication of the axis of rotation.

U.S. Pat. o. 4,136,387 describes a system for measuring the displacement of golf club heads in use, and also the movement of golf balls following impact with the club. The specification discloses the use of at least three non-collinear spots on the object, and requires the use of at least two electro-optical kinematic monitors to detect the positions of the spots at two closely spaced points in time. The disadvantage of such as ball-marking scheme and measurement system is the requirement for multiple sensors, and the non-uniqueness of the pattern of spots following rotational movement.

U.S. Pat. o. 6,390,934 describes a method of image processing of paint dots on golf balls. This patent is primarily concerned with the image processing method, but discloses the use of at least three, and preferably at least six dots on the golf ball, preferably arranged in a pentagonal pattern. Again, this approach has the disadvantage of the possibility of non-unique patterns of dots following a rotational translation.

The common feature of non-uniqueness of patterns of dots on balls following rotational movement has the consequence that situations might arise where it is impossible to determine whether, and if so how much, rotation has occurred by inspection of two images spaced apart in time.

Other approaches of measuring the spin on balls known to the applicants include the use of a ‘Great Circle’ marking (i.e. a single ‘equator’). This has the disadvantage that the system is unable to detect spin around an axis perpendicular to the plane of the great circle. A development of this technique using three orthogonal Great Circles has also been proposed. This approach again has disadvantages such as the existence of a 90° symmetry in the marking, thus preventing the measurement of rotation if the ball rotates more than this angle between subsequent images.

Accordingly it is an object of the present invention to provide a method of manufacture of projectiles, including but not limited to sports balls, that generates a total surface marking scheme such that any local view of the ball will present a visual pattern that can be identified as a unique set of features from which the ball's precise orientation around all three orthogonal space-frame axes can be determined. In this way, full 360° rotation around all axes can be accommodated. Thus, a ball or other object made according to the present invention may be used in a system for determining the spin on the object. Two successive images of the object may be captured at points closely spaced in time. The ability to uniquely determine the object's rotational orientation may then be used, with knowledge of the time interval between the two images, to determine the rate of spin and the spin axis.

It is also an object of the invention to provide a system for monitoring the movement imparted to a projectile, including but not limited to sports balls, that determines both the translational and rotational movement in space of a projectile following its launch.

### SUMMARY OF THE INVENTION

According to one embodiment of the present invention there is provided a system for measuring the flight of a projectile, comprising: a projectile comprising an exterior surface and a set of orientation identifiers distributed over the exterior surface, such that, for every orientation of the projectile, there exists, from any fixed perspective, a unique viewable configuration of a sub-set of the identifiers; means for capturing a first image of the surface of the projectile at a first time, the first image including a first configuration of a first sub-set of the orientation identifiers; means for determining the orientation of the projectile from the first configuration; means for capturing a second image of the surface of the projectile at a second time, the second image including a second configuration of a second sub-set of the orientation identifiers; means for determining the orientation of the projectile from the second configuration; and means for determining the rotational velocity of the projectile in flight from its orientation at the first time and its orientation at the second time.

According to another embodiment of the present invention there is provided a computer program comprising computer program instructions that when loaded into a computer provide means for determining the orientation of a projectile from a given configuration of a sub-set of the orientation identifiers, wherein the projectile comprises an exterior surface and a set of orientation identifiers distributed over the exterior surface, such that, for every orientation of the projectile, there exists, from any fixed perspective, a unique viewable configuration of a sub-set of the identifiers.

According to another embodiment of the present invention there is provided a method of determining the placement of orientation identifiers on the exterior surface of a projectile, comprising: a) defining an initial set of identifiers; b) distributing the set of identifiers over the surface of a simulated projectile; c) testing the existence of unique configurations of viewable identifiers for different orientations of the simulated projectile; d) adapting the distribution of identifiers, if the test fails, otherwise, simplifying the set of identifiers and returning to step b); and e) terminating the method.

According to another embodiment of the present invention there is provided a projectile comprising an exterior surface and a minimal set of orientation identifiers distributed over the exterior surface, such that, for every orientation of the projectile, there exists, from any fixed perspective, a unique viewable configuration of a sub-set of the identifiers.

According to another embodiment there is provided a method of marking a projectile such that any view of the surface of the projectile displays a pattern of projected markings that is unique to that view and to any rotation of that view; the method comprising the following steps:
(a) approximating the surface of said projectile by a polygonal mesh;
(b) choosing an initial number of markings as a trial number;
(c) distributing said number of markings at random about said polygonal mesh;
(d) applying an appropriate algorithm to remove from said distribution of markings any non-uniqueness of view within the region of confidence, and any perceived rotational symmetry in any one view;
(e) reducing said number of markings, and repeating steps (c) and (d) above; and
(f) repeating this process until no mathematical solution is obtainable;
the number and distribution of markings applicable to the projectile being determined by the solutions thereby obtained.

Advantageously, the least-number solution obtained by the method comprises a number of markings less than 55.

Also advantageously, the said features of the method comprise a plurality of regions, each said region being identified by one of a multiplicity of colours (as herein defined).

More advantageously, where the said features of the method comprise a plurality of regions, each said region being identified by one of a multiplicity of colours (as herein defined), step (d) of the method described above additionally removes from said distribution of markings any adjacent regions being identified by the same colour (as herein defined).

Advantageously also, where the said features of the method comprise a plurality of regions, each said region being identified by one of a multiplicity of colours (as herein defined), and step (d) of the method described above additionally removes from said distribution of markings any adjacent regions being identified by the same colour (as herein defined), the number of colours is less than 10.

Advantageously also, where the said features of the method comprise a plurality of regions, each said region being identified by one of a multiplicity of colours (as herein defined), and step (d) of the method described above additionally removes from said distribution of markings any adjacent regions being identified by the same colour (as herein defined), the number of colours is 5.

Included within the scope of the invention, is a method of marking a projectile substantially as described herein, with reference to and as illustrated in the accompanying drawings.

Also within the scope of the invention, is a projectile marked with a pattern coincident or substantially coincident with one obtained according to any of the embodiment of the invention.

Also within the scope is a system for monitoring movement imparted to a projectile, marked according to a method described above, comprising: launch detection means to detect the moment of launch of said projectile; image acquisition means to acquire images of said projectile, in flight; control means to activate said image acquisition means in reaction to the moment of launch of said projectile; processing means capable of determining the velocity and spin of said projectile by comparison of a plurality of images so acquired, and adapted to do so by virtue of being cognisant of the essentials of the marking method embodied in said projectile; and display means to display the velocity and spin to a user, in use.

### BRIEF DESCRIPTION OF THE DRAWINGS

FIG. 1 is a diagram illustrating the region of confidence (ROC) and outline view of a spherical object and an oblate spheroid.

FIG. 2 shows five views of a ball with surface markings according to the invention

FIG. 3 is a flow diagram defining an algorithm by which the method of the invention may be carried out.

FIG. 4 is an “opened out” net of a truncated icosahedron, showing a numbering scheme for its polygonal elements.

FIG. 5 is a pattern taken from a truncated icosahedral net, and a matrix of rotational codings of the pattern.

FIG. 6 is an “opened out” net of a truncated icosahedron, showing panel colours according to the invention.

FIG. 7 is a schematic diagram of the system for monitoring movement imparted to a projectile and

FIG. 8 illustrates the spin axes.

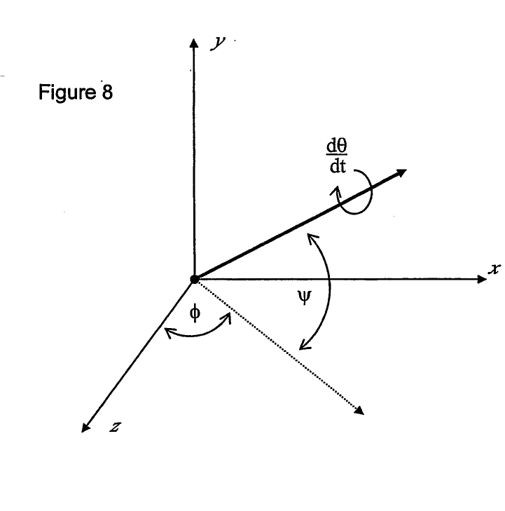

### DESCRIPTION OF THE PREFERRED EMBODIMENT

The method of marking according to the current invention generates a total surface marking scheme with the following features:
(a) For any view of the surface of the object (a view being defined in the everyday sense of the word, i.e. a projection of those surface markings of the object onto a plane parallel to a tangent to the surface of the object, and not intersecting the ball, said surface features comprising those surface features that can be projected onto the plane without intersecting the surface of the object) there is a pattern of projected features that is unique to that view, and to any rotation of that view.
(b) Subject to the constraints of (a), the pattern should be as simple as possible, to facilitate both manufacture and subsequent image analysis to determine the three dimensional orientation of the ball.

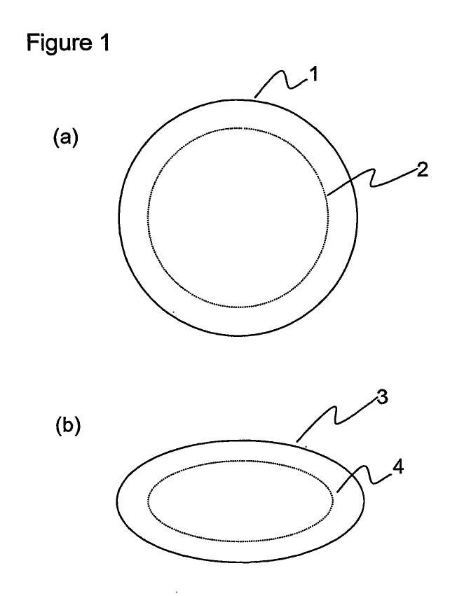

When creating a two dimensional view of an object, as described above, the separation of the projected surface features will be related not only to their separation on the surface of the object, but also to the difference between the angle of the projection plane and the angle of the plane tangential to the object at the point of surface marking. Where the tangent to the surface of the object is parallel to the projection plane the spatial separation of the surface features on the object and the spatial separation of the projection of those features on the projection plane will be identical; as the tangential plane tilts towards becoming normal to the projection plane the spatial separation of the projected surface features will become less than their separation on the surface of the object. In the case of a spherical object, for example, as the surface of the sphere curves away from the projected plane, equally-spaced surface features of the object will appear closer together on the projected image. This phenomenon can lead to inaccuracy in identification of the surface features. Therefore, for any object under study a ‘Region of Confidence’ (ROC) may be defined. The size and shape of this ROC will be dependent on the accuracy and shape of the markings on the object and the accuracy with which any image can be acquired or processed. FIG. 1(a) illustrates the projected image 1 of a spherical object such as a soccer ball, and the ROC 2 associated with that image. FIG. 1(b) illustrates the projected image 3 of a rugby ball, and its associated ROC 4.

The particular size and shape of the ROC is dependent on the shape of the object, and the characteristics of any image capture and analysis system, and can be readily defined, without inventive step, by those skilled in the art of image analysis. For spherical objects, the ROC is typically circular in projection, having approximately 80% of the surface area of the projection of the object itself.

Two specific embodiments of the invention will now be described. The first uses an arrangement of spots on the surface of a ball, and the second uses an array of individually identified regions, again on the surface of a ball. In each of the two embodiments that follow there is reference to a time allocated for calculation. It will be evident to any person skilled in the art of numerical simulation that the absolute magnitude of this time will be dependent upon the efficiency of calculation and the processing speed of any means (such as a computer program) used to carry out the calculations. The greater the allocated time for the calculation, the greater will be the confidence that an optimal solution has been discovered. Suitable times for a combination of a particular geometry, a coded embodiment of the algorithm, and characteristics of the computer used may be found by trial and error, and the uninventive judgement of any person skilled in the art of numerical simulation.

Those skilled in the art will recognise that the algorithms described in each of these two embodiments would be characterised as Genetic Algorithms. Other suitable algorithms could be used within the scope of the invention, such as, but not limited to simulated annealing, evolutionary programming, memetic algorithms, and dynamic hill climbing.

### Example A

### ‘Spot Scheme’

A pattern of spots may be generated according to the method of the invention in the following way: a) polygonal mesh is generated to approximate the surface of the ball, or other object, that is to be marked. For spherical balls this can be conveniently based on an icosahedron. Regular icosahedra are composed of 20 faces, each of which is an equilateral triangle. Each of these equilateral triangles may then be further subdivided, conveniently into four similar equilateral triangles, and the subdivision repeated as much as may be required. The solution to the problem then reduces to finding an arrangement of spots at the nodes of the mesh that satisfies the requirement of the invention. It will be appreciated that (a) the spots could be equally conveniently based in the centre of the triangular faces, or consistently at some other point on the mesh to achieve the same effect, and (b) the mesh could be made arbitrarily fine by successive subdivision.

It will be noted that the length of the sides of each of the triangles making up the polyhedron thus determine the minimum separation of the spots (i.e. the chordal distances between the spots) which is a useful design criteria for either the manufacturing process, or the subsequent identification of spot positions.

It will be appreciated that the spots used in any embodiment of the invention could be of arbitrary colour, shape, or reflective qualities. The size of the spots may also be chosen in a routine manner: large enough to be seen on any required image, and small enough to enable them to be resolved on any required image. The spots need not all have the same form.

It will be further appreciated that, for a given number of spots, there could be a very large number of possible arrangements on the mesh. Accordingly, there is provided an algorithm that is capable of automatically selecting a solution to the problem.

Spot Scheme Algorithm

(A1) Define a polygonal mesh to approximate the surface of the object. Methods of defining such meshes are well known in the art, and will not be needlessly listed here.

(A2) Set an initial spot count. For spherical objects it has been found that an initial spot count of 60 is suitable. For other geometries, higher initial spot counts may be required.

(A3) Randomly allocate the spots to unique points on the mesh, and define this arrangement as the ‘parent distribution’.

(A4) Create a random view (as defined above) of the spots on the polyhedral approximation to the ball.

(A5) Identify the sub-set of spots within the region of confidence (ROC) of this view.

(A6) For each spot in the ROC, calculate the set of chordal distances to each other spot in the ROC.

(A7) Compare these sets of chordal distances with the chordal distances to an equal number of neighbouring spots for each other spot on the complete mesh.

(A8) Count the number of other spots possessing identical chordal distance sets. Define each instance of identical chordal distance sets as a ‘violation’.

(A9) Add the number of violations for this viewpoint to any violations determined already for this ‘parent distribution’.

(A10) If the number of views examined for the current spot arrangement is less than N_{V}, then return to step A4. N_{V} can be chosen arbitrarily, but a typical number to achieve a high confidence in the solution is approximately 100,000.

(A11) Select a spot randomly from the parent distribution, and move it to a vacant site on the mesh, defining this new arrangement of spots as the ‘child distribution’.

(A12) Create a random view (as defined above) of the spots on the polyhedral approximation to the ball.

(A13) Identify the sub-set of spots within the region of confidence (ROC) of this view.

(A14) For each spot in the ROC, calculate the set of chordal distances to each other spot in the ROC.

(A15) Compare this set of chordal distances with the chordal distances to an equal number of neighbouring spots for each other spot on the complete mesh.

(A16) Count the number of other spots possessing identical chordal distance sets. Define each instance of identical chordal distance sets as a ‘violation’.

(A17) Add the number of violations for this view to any violations determined already for this ‘child distribution’.

(A18) If the number of views examined for the current spot arrangement is less than N_{V}, then return to step A12. N_{V} can be chosen arbitrarily, but a typical number to achieve a high confidence in the solution is approximately 100,000.

(A19) Compare the total number of violations for the parent and child distributions. If the total number of violations are different, define the distribution with the fewer number of violations as the new ‘parent distribution’, otherwise select one randomly, and define this as the new ‘parent distribution’.

(A20) If this new parent distribution has no violations, store the arrangement of spots, reduce the spot count by one, and return to step A3.

(A21) If fewer than N_{T} spot arrangements for the current spot count has been tried, return to step A11. For spherical geometries, it is found that choosing N_{T} to be approximately 100,000 leads to acceptable solutions. If solutions are not readily found using this number for the geometry in question, then N_{T} may be easily determined by trial-and-error.

(A22) If the maximum time allocated for the execution of this algorithm has not expired, return to step A2.

(A23) If an arrangement of spots has been stored as part of step A20, then the last of these to be stored is the preferred pattern of spots.

For a spherical object such as a ball, use of the algorithm outlined above shows that a solution may be reached using 50 spots. In this configuration, the ROC from any viewpoint typically shows approximately seven spots, each view being unique, both in respect of any rotation of any other view, and also in respect of any rotation the view itself. One solution using 50 spots is outlined in the table below, which gives the three x, y and z coordinates of spots on the surface of a sphere of unit radius, centred on (x,y,z)=(0,0,0). The spots are numbered arbitrarily from 1 to 50 for purposes of identification. The coordinates are given to three decimal places, but it will be appreciated that this level of accuracy is not required, as the spacing of the spots at the vertices of a polyhedral mesh ensures that the uniqueness of the chordal distances between any two spots will not be violated by small errors in spot positioning.

| Spot | | | |
|---|---|---|---|
| Number | x | y | z |
| 1 | −0.905 | −0.156 | 0.395 |
| 2 | −0.552 | −0.345 | 0.759 |
| 3 | 0.381 | 0.782 | 0.495 |
| 4 | −0.408 | −0.016 | 0.913 |
| 5 | 0.454 | 0.885 | 0.102 |
| 6 | −0.651 | 0.671 | 0.355 |
| 7 | 0.739 | −0.009 | −0.673 |
| 8 | −0.276 | 0.447 | −0.851 |
| 9 | 0.497 | 0.647 | 0.578 |
| 10 | −0.905 | −0.156 | −0.395 |
| 11 | 0.112 | −0.932 | −0.343 |
| 12 | 0.734 | 0.671 | −0.104 |
| 13 | −0.359 | 0.782 | −0.510 |
| 14 | −0.395 | 0.307 | −0.866 |
| 15 | −0.854 | 0.490 | −0.175 |
| 16 | −0.705 | −0.647 | 0.290 |
| 17 | −0.797 | 0.604 | 0.000 |
| 18 | 0.656 | 0.156 | −0.738 |
| 19 | −0.604 | −0.797 | −0.007 |
| 20 | −0.494 | −0.647 | −0.581 |
| 21 | −0.207 | −0.015 | 0.978 |
| 22 | −0.374 | −0.782 | −0.499 |
| 23 | −0.702 | −0.307 | −0.643 |
| 24 | 0.928 | 0.357 | 0.104 |
| 25 | −0.192 | −0.365 | 0.912 |
| 26 | −0.453 | −0.885 | −0.110 |
| 27 | 0.898 | −0.178 | −0.403 |
| 28 | 0.184 | −0.983 | 0.000 |
| 29 | 0.202 | 0.008 | −0.979 |
| 30 | 0.702 | 0.306 | 0.643 |
| 31 | 0.190 | 0.357 | −0.915 |
| 32 | −0.395 | 0.307 | 0.866 |
| 33 | 0.359 | −0.782 | −0.510 |
| 34 | −0.247 | 0.953 | −0.177 |
| 35 | 0.539 | −0.671 | −0.509 |
| 36 | −0.588 | −0.490 | 0.643 |
| 37 | 0.303 | 0.195 | 0.933 |
| 38 | 0.318 | 0.671 | −0.670 |
| 39 | 0.525 | −0.851 | 0.000 |
| 40 | −0.812 | 0.357 | 0.462 |
| 41 | 0.905 | 0.156 | 0.395 |
| 42 | 0.112 | −0.932 | 0.343 |
| 43 | 0.148 | 0.983 | 0.108 |
| 44 | 0.588 | 0.000 | 0.808 |
| 45 | 0.894 | 0.342 | −0.290 |
| 46 | −0.427 | 0.885 | 0.185 |
| 47 | −0.656 | −0.156 | −0.738 |
| 48 | 0.651 | −0.671 | 0.355 |
| 49 | 0.688 | −0.525 | 0.500 |
| 50 | 0.430 | −0.490 | 0.758 |

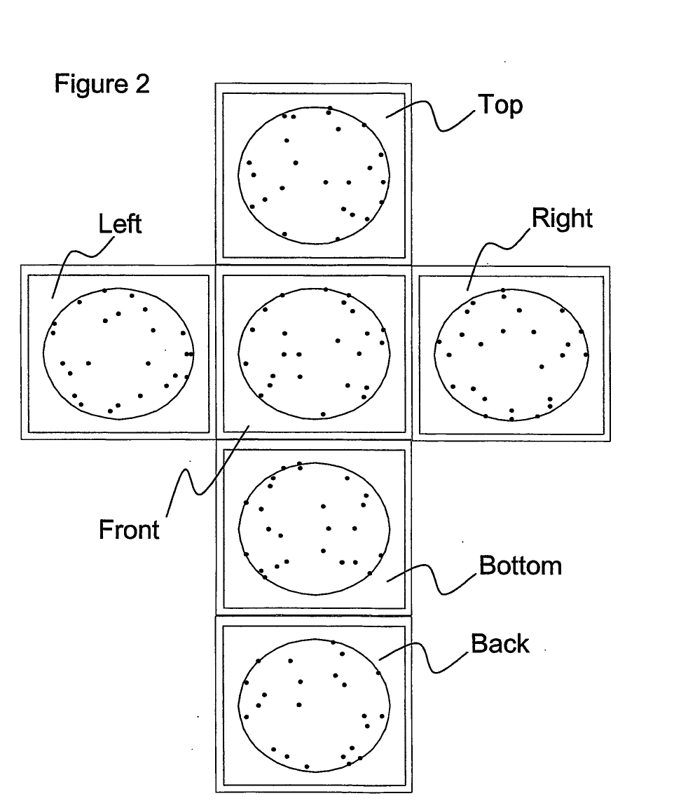

FIG. 2 illustrates six views of this arrangement of spots, showing the ball viewed from the front, back, left side, right side, from the top, and from the bottom.

### Example B

### ‘Coloured Panel Scheme’

The embodiment described in this example is particularly suitable for balls constructed of, or displaying surface features substantially comprising a number of two-dimensional tessellating panels. An example of this would be a common soccer ball, which takes the form of a truncated icosahedron, comprised of twelve regular pentagonal, and twenty regular hexagonal adjoining panels. When inflated, the flexible nature of the construction material of the panels creates a ball that approximates a sphere. This embodiment takes advantage of the panelled nature of the ball to create a total surface marking scheme such that any local view of the ball presents a visual pattern that can be identified as a unique set of features from which the ball's precise orientation around all three orthogonal space-frame axes can be determined. In this embodiment, we define a ‘pattern’ as comprising a panel and its surrounding neighbours. This means that a pattern will contain six or seven features (depending whether the central panel is a pentagon or hexagon, respectively) that we can utilise in establishing the uniqueness of the pattern. The unique patterns are defined by identifying each panel with, for example, a colour. It is appreciated, of course, that any number of panel distinguishing features could be used, such as numbers, geometric shapes, letters or any other series of marks, without inventive departure from the current invention. For the purpose of clarity, we will refer subsequently to the distinguishing feature as a colour.

To facilitate practical visual discrimination of the panels during any subsequent spin-determination, it is to be preferred that no two adjoining panels are the same colour. As in example A, each pattern in a coloured panel scheme according to the method of this invention, must be unique within itself, i.e. rotation of the pattern will not find a match. (For example a regular hexagonal panel with neighbours coloured black, white, black, white, black, white, would violate this condition every 120°). Furthermore, each pattern must also be unique when compared to all 31 other patterns on the ball.

It will be appreciated that for colours and p panels in a ball, there will N^{p} possible choices of colour arrangements. Only a few of these arrangements will satisfy the uniqueness criteria outlined above. For 5 colours and the 32 panels in a truncated icosahedral soccer ball this amounts to in excess of 2×10²² possibilities. It will further be appreciated that with such a large number of possibilities, it would impractical to find an arrangement of colours that meet the required criteria, simply by a matter of trial and error. Accordingly, there is provided below an algorithm that is capable of selecting an arrangement of coloured panels according to the present invention.

Coloured-Panel Algorithm

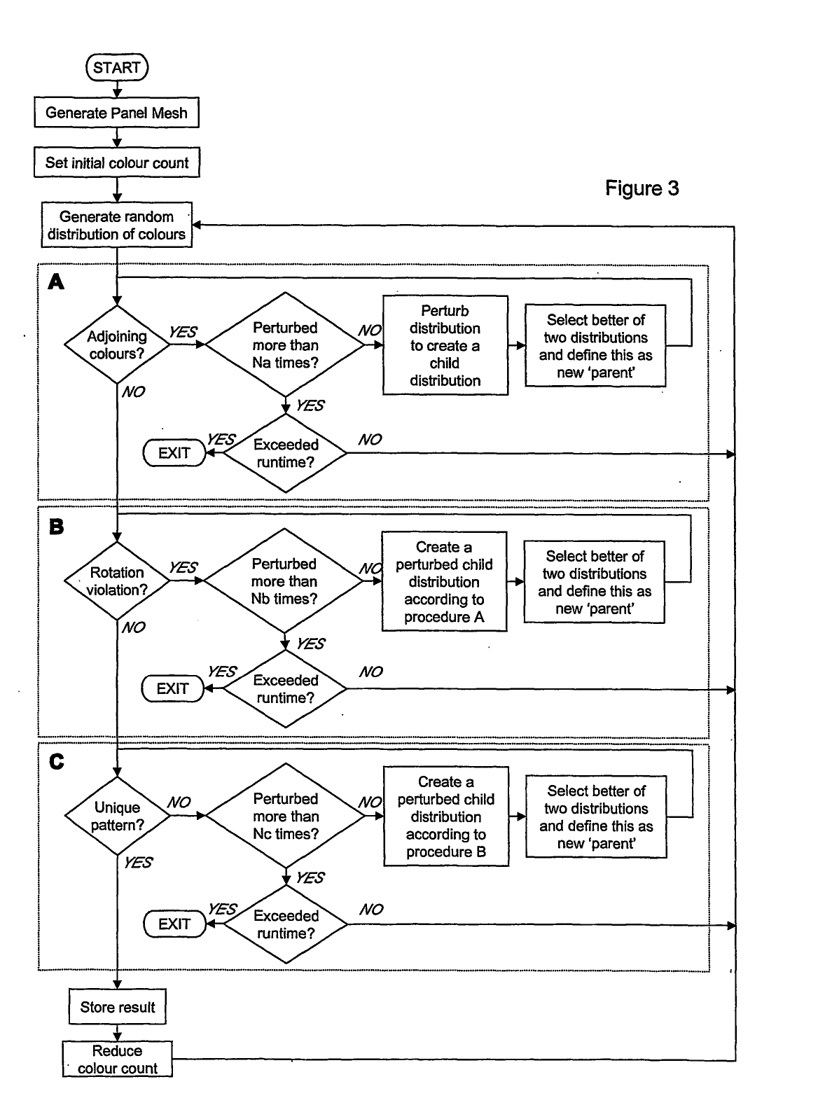

The flow chart depicted in FIG. 3 illustrates an algorithm capable of selecting the colours of a series of panels to meet the requirements of the invention. At the start of the algorithm a panel mesh is defined to mimic the surface of the ball, or other object under study. Such methods of approximating curved and complex surfaces are well-known in the field of computer modelling, and will not be needlessly listed here. For the case of a typical soccer ball, this panel will comprise 12 regular pentagons and 20 regular hexagons. The table below shows relationships for such a panel mesh, and for each panel in the mesh (numbered 1 to 32), identifies the its neighbouring panels.

| | |
|---|---|
| Panel | |
| Number | Neighbouring Panels |

Pentagons

| | | | | | |
|---|---|---|---|---|---|
| 1 | 29 | 27 | 28 | 14 | 13 |
| 2 | 28 | 22 | 21 | 15 | 14 |
| 3 | 14 | 15 | 16 | 17 | 13 |
| 4 | 13 | 17 | 31 | 30 | 29 |
| 5 | 26 | 24 | 27 | 29 | 30 |
| 6 | 31 | 32 | 25 | 26 | 30 |
| 7 | 20 | 19 | 21 | 22 | 23 |
| 8 | 20 | 23 | 24 | 26 | 25 |
| 9 | 24 | 23 | 22 | 28 | 27 |
| 10 | 18 | 32 | 31 | 17 | 16 |
| 11 | 20 | 25 | 32 | 18 | 19 |
| 12 | 21 | 19 | 18 | 16 | 15 |

Hexagons

| | | | | | | |
|---|---|---|---|---|---|---|
| 13 | 29 | 1 | 14 | 3 | 17 | 4 |
| 14 | 1 | 28 | 2 | 15 | 3 | 13 |
| 15 | 14 | 2 | 21 | 12 | 16 | 3 |
| 16 | 17 | 3 | 15 | 12 | 18 | 10 |
| 17 | 4 | 13 | 3 | 16 | 10 | 31 |
| 18 | 10 | 16 | 12 | 19 | 11 | 32 |
| 19 | 18 | 12 | 21 | 7 | 20 | 11 |
| 20 | 25 | 11 | 19 | 7 | 23 | 8 |
| 21 | 7 | 19 | 12 | 15 | 2 | 22 |
| 22 | 23 | 7 | 21 | 2 | 28 | 9 |
| 23 | 8 | 20 | 7 | 22 | 9 | 24 |
| 24 | 26 | 8 | 23 | 9 | 27 | 5 |
| 25 | 32 | 11 | 20 | 8 | 26 | 6 |
| 26 | 6 | 25 | 8 | 24 | 5 | 30 |
| 27 | 5 | 24 | 9 | 28 | 1 | 29 |
| 28 | 1 | 27 | 9 | 22 | 2 | 14 |
| 29 | 30 | 5 | 27 | 1 | 13 | 4 |
| 30 | 6 | 26 | 5 | 29 | 4 | 31 |
| 31 | 32 | 6 | 30 | 4 | 17 | 10 |
| 32 | 11 | 25 | 6 | 31 | 10 | 18 |

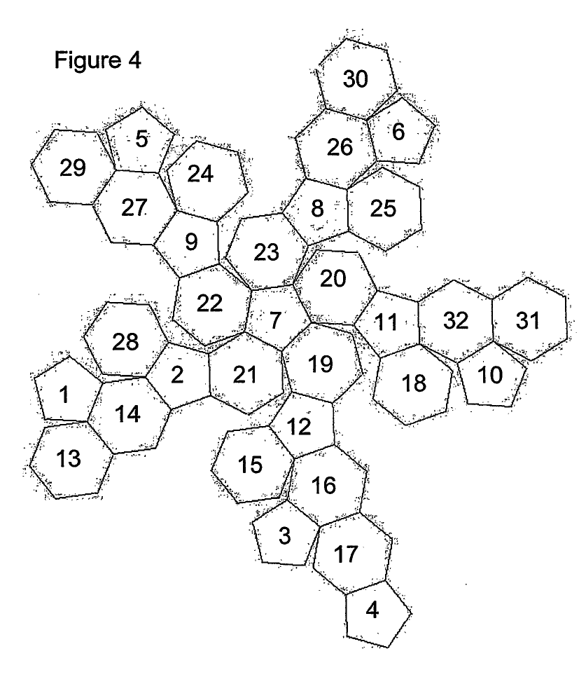

This arrangement of numbered panels is illustrated in FIG. 4, where the truncated icosahedral mesh has been “opened flat” into a net.

Returning again to FIG. 3, the second step in the algorithm is to set an initial colour count for the mesh. Clearly, setting this colour count to equal the number of panels in the mesh will always result in an arrangement of panels that satisfies the criteria. However, one object of the invention is to minimise the number of colours required for identification, and it has been found that for the truncated icosahedral shape of the soccer ball, a suitable initial colour count would be ten.

There then follows a series of three procedures, enclosed in FIG. 3 by boxes, and labelled A, B and C.

Procedure A is concerned with eliminating ‘colour violations’ from the distribution of colours. A colour violation is defined as the existence of two adjoining panels of the same colour. If the starting distribution does contain colour violations, a second ‘child distribution’ is generated by randomly selecting one of the panels, and changing its colour, randomly, to a different colour. The number of colour violations is calculated for both the parent and the child distributions. If the total number of colour violations are different, the distribution with the fewer number of colour violations is defined as the new ‘parent distribution’, otherwise one of the distributions is selected at random, and defined as the new ‘parent distribution’. It will be clear from FIG. 3 that procedure A also contains two tests. The first test checks whether the described perturbation process has been carried out more than a predetermined number of times, denoted N_{A}. N_{A} may be conveniently chosen by trial and error, but a satisfactory number for the case of a truncated icosahedron is 10,000. If more than N_{A} perturbations have occurred, but the time allocated for the performance of the algorithm has not been exceeded, then the distribution on the panel mesh is randomised completely, and the process started over again. In the second test, if the allocated time for performance of the algorithm has been exceeded, then the algorithm terminates.

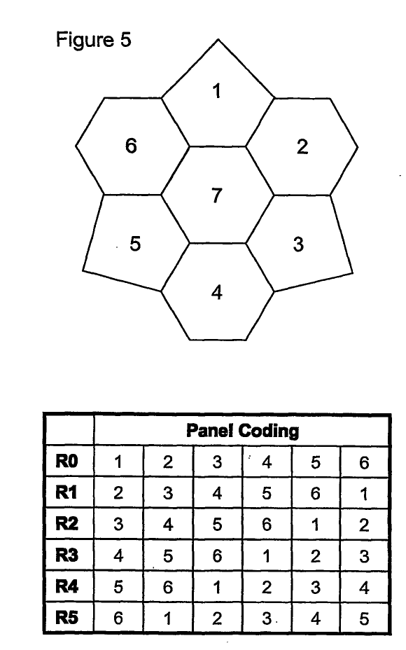

Procedure B is concerned with eliminating ‘rotation violations’ from the distribution of colours on the mesh. A rotation violation is most conveniently defined by reference to FIG. 5. This depicts seven panels forming a ‘pattern’ taken from the truncated icosahedral mesh that defines the surface of a soccer ball. The central hexagonal panel labelled 7 is surrounded by 6 adjoining panels, labelled 1 to 6. Panels 1, 3 and 5 are pentagons, and panels 2, 4 and 6 are hexagons. Also shown in FIG. 5 is a matrix showing the 6 possible rotational positions of the pattern labelled R0 to R5. To determine the existence of a rotation violation, the panel numbers are replaced by their respective colour codings. If any of the lines in the matrix are identical, then this constitutes a rotation violation. It will be clear to those skilled in the art that the definition of ‘rotation violation’ for other mesh geometries is trivial and self-evident.

Procedure B takes as its starting point a parent distribution of colours that contains no colour violations, and proceeds to determine the number of rotation violations in the distribution. If rotation violations are found, a perturbed child distribution is created, containing no colour violations, achieved using procedure A. The number of rotation violations for the two distributions are then compared. If the number of rotation violations are different, the distribution with the fewer number of rotation violations is defined to be the new ‘parent distribution’, otherwise one is selected randomly and defined as the new ‘parent distribution’. This new ‘parent distribution’ then forms the input to procedure B until the procedure either exits with a distribution containing neither colour violations nor rotation violations, or the algorithm terminates or the algorithm restarts as described above.

Reference to FIG. 3 shows that procedure B also contains 2 tests, in an analogous way to procedure A. One test allows for a time-out. Another test allows for a maximum of B perturbations to the colour distribution. As before, B may be conveniently chosen by trial and error, but a satisfactory number for the case of a truncated icosahedron is 10,000.

Procedure C is concerned with ensuring that all patterns created are unique. The procedure takes as its starting point a parent distribution that contains neither colour violations, nor rotation violations, as may be produced by procedure B. A ‘uniqueness violation’ may be described by a reference again to FIG. 5. For each panel in the mesh, the panel and its immediate neighbours constitute a ‘pattern’, depicted in FIG. 5 for the case of a central hexagonal panel in a truncated icosahedral mesh. Each pattern, in each of its rotational positions, is compared with each other pattern in the mesh, again in each of the possible rotational positions of that panel. A ‘uniqueness violation’ is said to occur if a match is found.

If ‘uniqueness violations’ are found in the parent distribution, a perturbed child distribution is created, containing neither colour nor rotation violations, achieved using procedure B. The number of uniqueness violations for the two distributions are then compared. If the number of uniqueness violations are different, the distribution with the fewer number of uniqueness violations is defined to be the new ‘parent distribution’, otherwise one is selected randomly and defined as the new ‘parent distribution’. This new ‘parent distribution’ then forms the input to procedure C until the procedure either exits with a distribution meeting all three design criteria, all the algorithm terminates, or the algorithm restarts as described above.

On completion of procedure C, with a distribution of colours meeting all three design criteria, this distribution is stored as a candidate solution to the problem. As an object of the invention is to provide such a surface marking scheme containing as few colours as possible, the allowable colour count in the algorithm is reduced by one, and the process is repeated as indicated in FIG. 3.

It should be appreciated that the choice of evolving colour distributions to meet first the colour violation criterion, followed by the rotation violation criterion, and finally the uniqueness criterion is somewhat arbitrary. The three criteria could readily be satisfied in any order.

For the case of the 32-sided truncated icosahedral shape of a soccer ball, it has been found that a solution to the problem may be obtained with the use of only five different colours. The table below identifies such a solution; each panel (numbered as described in the above table, and in FIG. 4) is assigned a colour, each colour numbered from 1 to 5.

| | |
|---|---|
| Panel No. | Colour |

Pentagons

| | |
|---|---|
| 1 | 4 |
| 2 | 4 |
| 3 | 4 |
| 4 | 5 |
| 5 | 5 |
| 6 | 5 |
| 7 | 5 |
| 8 | 3 |
| 9 | 3 |
| 10 | 1 |
| 11 | 5 |
| 12 | 5 |

Hexagons

| | |
|---|---|
| 13 | 1 |
| 14 | 5 |
| 15 | 1 |
| 16 | 3 |
| 17 | 2 |
| 18 | 4 |
| 19 | 3 |
| 20 | 1 |
| 21 | 2 |
| 22 | 1 |
| 23 | 2 |
| 24 | 4 |
| 25 | 4 |
| 26 | 2 |
| 27 | 1 |
| 28 | 2 |
| 29 | 2 |
| 30 | 4 |
| 31 | 3 |
| 32 | 2 |

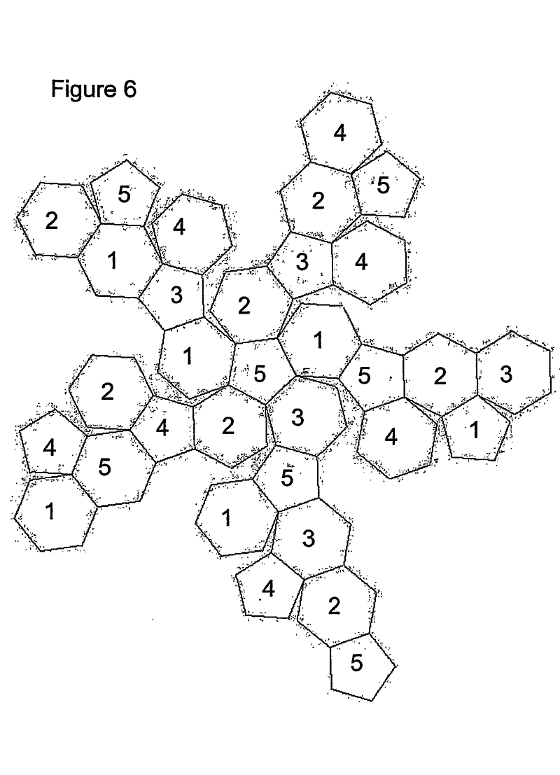

The arrangement of colour allocations described in this table is further illustrated in FIG. 6, where each of the panels in an “opened out” mesh of a truncated icosahedron is labelled with its allocated colour. It will be appreciated that more than one such arrangement of colours may be generated within the scope of this invention.

### DESCRIPTION OF THE PREFERRED EMBODIMENT

The preferred embodiment of the system for monitoring such a marked projectile comprises a projectile wherein the marking comprises a series of panels, as described above.

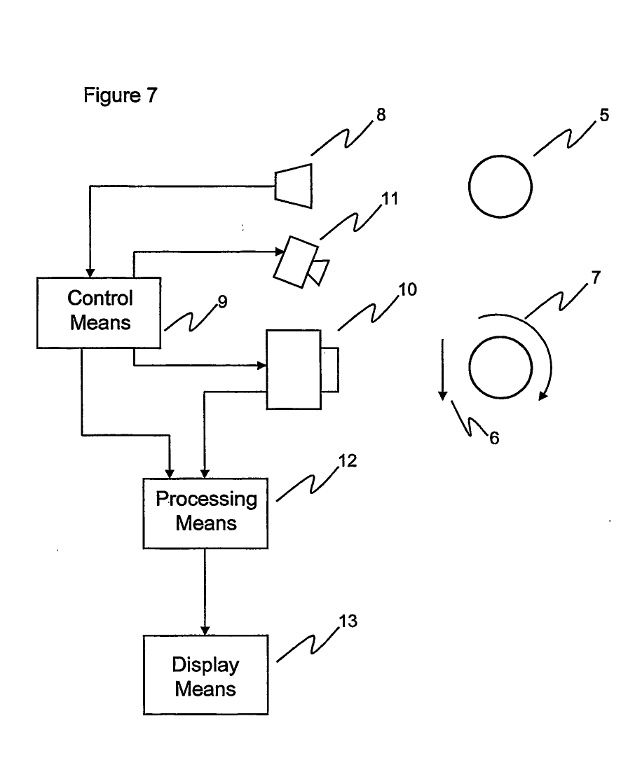

With reference to FIG. 7, in this embodiment, the projectile 5 of interest is a football (UK soccer ball) whose surface is marked with a number of coloured panels. In use, a user imparts movement to the projectile 5, for example by kicking the football, thus imparting both translational and rotational movement to the ball indicated by the arrows 6 and 7. The launch of the projectile 5 is detected by the launch detection means 8. In this embodiment, this means comprises a sound trigger, i.e. a microphone device. The launch detection means 8 sends a signal through the control means 9, which may conveniently comprise either a computer system with appropriate hardware, itself known in the art, or another electronic or electrical device. The control means 9 controls a 30 frames per second digital camera 10 with a 1/8000 second shutter speed. In this embodiment, this choice of camera and shutter speed is appropriate for the range of translational and rotational movements imparted to a football by a skilled player. The control means 9 also trigger one or more flash guns 11. The control means has a time delay between detection of launch of the projectile 5 and triggering one or more flash guns 11. For the case of a football-monitoring device, a typical time delay will be around 70 ms.

Following the acquisition of a series of images of the moving projectile 5 the images are transmitted to the processing means 12. The processing means 12 in this embodiment resides on the same computer as the control means 9, but could, if required, be separate.

The processing means 12 selects two images from those acquired, each containing an image of the projectile 5 and separated in time. At the typical frame rate described above, and at a kicking speed of 35 m/s (a typical maximum velocity for a football kicked by a professional player) successive frames will show images of the ball approximately 1 metre apart.

By virtue of the unique arrangement of panels on the projectile 5, analysis of the translational and rotational movement of the projectile 5 may be effected by image analysis. A suitable algorithm for such analysis is as follows:

Two images are selected from those collected, each showing the projectile within the same overall frame of view. These images represent a moving foreground object with a substantially static background, subtraction of the images one from another will eliminate the background, and identify the position of the moving projectile. This subtraction methodology is often referred to as ‘differencing’ in the field of image analysis. The resultant images can be enhanced and cleaned by use of standard image analysis techniques, such as shadow removal and filtering. The known size of the projectile may be used to determine the scaling of the image. From a knowledge of this scaling, and the orientation of the images, the velocity component in a plane parallel to the plane of the camera may thus be determined. The change in the size in the image of the projectile from one frame to another may be used to obtain the velocity component of the projectile in the direction perpendicular to the plane of the camera. These calculations thus give a measure of the speed and angle (i.e. the velocity) of the projectile at launch.

Having identified the position of the projectiles in the two images by the subtraction described above, these may be used to identify, and therefore construct a mask to identify the areas of interest in the original images. Where, as in this embodiment, the projectile is marked with a series of coloured panels, colour analysis and segmentation of the image may readily be applied to identify the central location of each panel visible, its colour identification and its area. This will provide an array of six or seven (x, y) co-ordinates, areas and colours.

The largest visible area is likely to be that closest to the camera, and therefore have the most accurate position and area data. The list of co-ordinates and associated data may therefore be sorted on the basis of this area.

From knowledge of the location of each of the coloured panels on the projectile a look-up table may be constructed containing the 3-D co-ordinates of the centres of the panels (32 in the case of a truncated icosahedron that is often used to approximate a spherical football). This table represents an arbitrary reference frame within which rotational translations of the projectile may be defined. From the table, a matrix (32×32 for the truncated icosahedron) of chordal distances (The ‘Chordal Distance Matrix’) between the centre points of the panels may be constructed, together with the colour reference of each panel.

From the image analysis, a table of panel locations may be constructed. The centre point of each visible panel (typically six or seven panels for a truncated icosahedron) as projected onto the image panel (xᵢ, yᵢ) may be located by standard image analysis techniques. Then, using a knowledge of the radius of the projectile, and the position of the projected centre points (xᵢ, yᵢ) with respect to the outline of the projectile, the true 3-dimensional coordinates of the centre points (x, y, z) may be calculated and the chordal distances between each of the panel centre points calculated.

A search of this Chordal Distance Matrix for matching colour references and chordal distances will identify each of the visible panels with respect to the marking scheme of the projectile.

Having identified the identity and location of the panels, the unique orientation of the projectile in space for each of the two images may then be calculated. Matrix algebra may be used to transform an original (arbitrary) reference frame to the new observed reference frame of the projectile. In this way, both the rotational rate and the axis of the rotation of the projectile may be determined. By reference to FIG. 2, this may be conveniently expressed by reference to an orthogonal reference frame (x, y, z) by two angles φ and ψ and an angular rotational rate (dθ/dt).

The invention is described in the claims that follow, and in which the term “colour” is understood to include any number of panel distinguishing features, such as differences in reflective qualities, numbers, geometric shapes, letters or any other series of marks, as well as “colours” in the everyday sense of the word, without inventive departure from the current invention.

1-47. (canceled)

48. A system for measuring the flight of a projectile, comprising:
a projectile comprising an exterior surface and a set of orientation identifiers distributed over the exterior surface, such that, for every orientation of the projectile, there exists, from any fixed perspective, a unique viewable configuration of a sub-set of the identifiers;
means for capturing a first image of the surface of the projectile at a first time, the first image including a first configuration of a first sub-set of the orientation identifiers;
means for determining the orientation of the projectile from the first configuration;
means for capturing a second image of the surface of the projectile at a second time, the second image including a second configuration of a second sub-set of the orientation identifiers;
means for determining the orientation of the projectile from the second configuration; and
means for determining the rotational velocity of the projectile in flight from its orientation at the first time and its orientation at the second time.

49. A system as claimed in claim 48, further comprising means for determining the translation velocity of the projectile from the first and second images.

50. A system as claimed in claim 48, comprising a processor for providing means for determining the orientation of the projectile from a configuration of a sub-set of the orientation identifiers.

51. A record carrier embodying a computer program comprising computer program instructions that when loaded into a computer provide means for determining the orientation of a projectile from a given configuration of a sub-set of the orientation identifiers, wherein the projectile comprises an exterior surface and a set of orientation identifiers distributed over the exterior surface, such that, for every orientation of the projectile, there exists, from any fixed perspective, a unique viewable configuration of a sub-set of the identifiers.

52. A method of determining the placement of orientation identifiers on the exterior surface of a projectile, comprising:
a) defining an initial set of identifiers;
b) distributing the set of identifiers over the surface of a simulated projectile;
c) testing the existence of unique configurations of viewable identifiers for different orientations of the simulated projectile;
d) adapting the distribution of identifiers, if the test fails, otherwise, simplifying the set of identifiers and returning to step b); and
e) terminating the method.

53. A method as claimed in claim 52, wherein the projectile is simulated using a polygonal mesh that approximates the surface of the projectile.

54. A method as claimed in claim 52, wherein the step of testing comprises testing the existence of a unique configuration of a sub-set of the viewable identifiers for each orientation of the simulated projectile.

55. A method as claimed in claim 52, wherein the step of testing comprises running the following process a specified number of times:
(i) determining a random orientation;
(ii) determining, for that orientation, the configuration of a sub-set of viewable identifiers;
(iii) calculating a measure of the configuration of the sub-set of viewable identifiers;
(iv) comparing the calculated measure with measures of the configurations of similar sub-sets of viewable identifiers for different orientations (v) return to (i),
wherein the test fails if there are positive comparisons.

56. A method as claimed in claim 52, wherein the step of adapting the distribution of identifiers comprises the random movement of one identifier.

57. A method as claimed in claim 52, wherein the step of simplifying the set of identifiers comprises reducing the number of identifiers.

58. A method as claimed in claim 52, wherein the set of identifiers comprises the colors of tessellating panels of the projectile.

59. A method as claimed in claim 58, wherein the step of distributing the set of identifiers comprises randomly distributing the colors over the panels.

60. A method as claimed in claim 58, wherein test fails if there is the same configuration of viewable identifiers for different orientations of the simulated projectile.

61. A method as claimed in claim 58, wherein the step of adapting the distribution of identifiers comprises the random change of the color of a panel.

62. A method as claimed in claim 58, wherein the step of simplifying the set of identifiers comprises a reduction in the number of colors used to color the tessellating panels of the projectile.

63. A record carrier embodying a computer program for performing the method of determining the placement of orientation identifiers on the exterior surface of a projectile, comprising:
a) defining an initial set of identifiers;
b) distributing the set of identifiers over the surface of a simulated projectile;
c) testing the existence of unique configurations of viewable identifiers for different orientations of the simulated projectile;
d) adapting the distribution of identifiers, if the test fails, otherwise, simplifying the set of identifiers and returning to step b); and
e) terminating the method.

64. A projectile comprising an exterior surface and a minimal set of orientation identifiers distributed over the exterior surface, such that, for every orientation of the projectile, there exists, from any fixed perspective, a unique viewable configuration of a sub-set of the identifiers.

65. A projectile as claimed in claim 64, comprising a plurality of colored tessellating panels having a minimal number of different colors.

66. A projectile as claimed in claim 65, comprising 32 tessellating panels distributed over the exterior surface of the projectile according to the following table:

| | |
|---|---|
| Panel | |
| Number | Neighbouring Panels |

Pentagons

| | | | | | |
|---|---|---|---|---|---|
| 1 | 29 | 27 | 28 | 14 | 13 |
| 2 | 28 | 22 | 21 | 15 | 14 |
| 3 | 14 | 15 | 16 | 17 | 13 |
| 4 | 13 | 17 | 31 | 30 | 29 |
| 5 | 26 | 24 | 27 | 29 | 30 |
| 6 | 31 | 32 | 25 | 26 | 30 |
| 7 | 20 | 19 | 21 | 22 | 23 |
| 8 | 20 | 23 | 24 | 26 | 25 |
| 9 | 24 | 23 | 22 | 28 | 27 |
| 10 | 18 | 32 | 31 | 17 | 16 |
| 11 | 20 | 25 | 32 | 18 | 19 |
| 12 | 21 | 19 | 18 | 16 | 15 |

Hexagons

| | | | | | | |
|---|---|---|---|---|---|---|
| 13 | 29 | 1 | 14 | 3 | 17 | 4 |
| 14 | 1 | 28 | 2 | 15 | 3 | 13 |
| 15 | 14 | 2 | 21 | 12 | 16 | 3 |
| 16 | 17 | 3 | 15 | 12 | 18 | 10 |
| 17 | 4 | 13 | 3 | 16 | 10 | 31 |
| 18 | 10 | 16 | 12 | 19 | 11 | 32 |
| 19 | 18 | 12 | 21 | 7 | 20 | 11 |
| 20 | 25 | 11 | 19 | 7 | 23 | 8 |
| 21 | 7 | 19 | 12 | 15 | 2 | 22 |
| 22 | 23 | 7 | 21 | 2 | 28 | 9 |
| 23 | 8 | 20 | 7 | 22 | 9 | 24 |
| 24 | 26 | 8 | 23 | 9 | 27 | 5 |
| 25 | 32 | 11 | 20 | 8 | 26 | 6 |
| 26 | 6 | 25 | 8 | 24 | 5 | 30 |
| 27 | 5 | 24 | 9 | 28 | 1 | 29 |
| 28 | 1 | 27 | 9 | 22 | 2 | 14 |
| 29 | 30 | 5 | 27 | 1 | 13 | 4 |
| 30 | 6 | 26 | 5 | 29 | 4 | 31 |
| 31 | 32 | 6 | 30 | 4 | 17 | 10 |
| 32 | 11 | 25 | 6 | 31 | 10 | 18 |

67. A projectile as claimed in claim 66, wherein 5 different colors are assigned to the 32 tessellating panels according to the following table:

| | |
|---|---|
| Panel | |
| No. | Color |

Pentagons

| | |
|---|---|
| 1 | 4 |
| 2 | 4 |
| 3 | 4 |
| 4 | 5 |
| 5 | 5 |
| 6 | 5 |
| 7 | 5 |
| 8 | 3 |
| 9 | 3 |
| 10 | 1 |
| 11 | 5 |
| 12 | 5 |

Hexagons

| | |
|---|---|
| 13 | 1 |
| 14 | 5 |
| 15 | 1 |
| 16 | 3 |
| 17 | 2 |
| 18 | 4 |
| 19 | 3 |
| 20 | 1 |
| 21 | 2 |
| 22 | 1 |
| 23 | 2 |
| 24 | 4 |
| 25 | 4 |
| 26 | 2 |
| 27 | 1 |
| 28 | 2 |
| 29 | 2 |
| 30 | 4 |
| 31 | 3 |
| 32 | 2 |
